(19) United States
(12) Patent Application Publication
(10) Pub. No.: US 2022/0172396 A1
(43) Pub. Date: Jun. 2, 2022

(54) VEHICLE POSITION ESTIMATION APPARATUS

(71) Applicant: Honda Motor Co., Ltd., Tokyo (JP)

(72) Inventor: Yuki Okuma, Wako-shi (JP)

(21) Appl. No.: 17/536,072

(22) Filed: Nov. 28, 2021

(30) Foreign Application Priority Data
Dec. 2, 2020 (JP) 2020-200051

(51) Int. Cl. G06T 7/73; G06V 20/58; G06T 7/12; G06T 7/11; G06V 10/70; G06T 7/246

(52) U.S. Cl. CPC G06T 7/74; G06V 20/58; G06T 7/12; G06T 7/11; G06T 2207/20081; G06T 7/248; G06T 2207/10028; G06T 2207/30252; G06V 10/70

(57) ABSTRACT

A vehicle position estimation apparatus includes a microprocessor configured to perform recognizing a moving object included in a detection region specified by a detection data acquired by a detection unit mounted on a vehicle, partitioning the detection region specified by the detection data acquired by the detection unit into a first region including the moving object and a second region not including the moving object, extracting a feature point of the detection data from the second region, and executing a predetermined processing based on the feature point corresponding to the second region among the extracted feature points extracted. The microprocessor is configured to execute at least one of a processing of generating a point cloud map using the extracted feature point and a processing of estimating a position of the vehicle based on a change over time in a position of the acquired detection data.

### CROSS-REFERENCE TO RELATED APPLICATION

This application is based upon and claims the benefit of priority from Japanese Patent Application No. 2020-200051 filed on Dec. 2, 2020, the content of which is incorporated herein by reference.

### BACKGROUND OF THE INVENTION

### Field of the Invention

This invention relates to a vehicle position estimation apparatus configured to estimate a current position of a vehicle.

### Description of the Related Art

Conventionally, there is a known apparatus of this type, configured to estimate a current position of a vehicle on a map based on the current position of the vehicle and acquired by a GPS receiver and map information. Such an apparatus is disclosed, for example, in Japanese Unexamined Patent Publication No. 2017-9554 (JP2017-9554A). In the apparatus described in JP2017-9554A, a region where a road sign is expected to be present is specified from a captured image around the vehicle acquired by an in-vehicle camera, a relative position of the vehicle with respect to the road sign is calculated based on an image of the specified region, and a current position of the vehicle in map information is estimated using the calculation result.

However, since the height and position at which the road sign is installed are different for each road sign, it is difficult to accurately estimate the current position of the vehicle in the map information by specifying the region where the road sign is expected to be present as in the apparatus described in JP2017-9554A.

### SUMMARY OF THE INVENTION

An aspect of the present invention is a vehicle position estimation apparatus including a detection unit mounted on a vehicle and detecting an external circumstance around the vehicle and a microprocessor and a memory coupled to the microprocessor. The microprocessor is configured to perform recognizing a moving object included in a detection region specified by a detection data acquired by the detection unit, partitioning the detection region specified by the detection data acquired by the detection unit into a first region including the moving object and a second region not including the moving object, extracting a feature point of the detection data from the second region; and executing a predetermined processing based on the feature point corresponding to the second region among the feature points extracted in the extracting. The microprocessor is configured to perform the executing including executing at least one of a processing of generating a point cloud map using the feature point extracted in the extracting and a processing of estimating a position of the vehicle based on a change over time in a position of the detection data acquired by the detection unit.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle incorporating a vehicle control system according to an embodiment of the present invention;

FIG. 2 is a block diagram schematically illustrating an overall configuration of a vehicle control system according to an embodiment of the present invention;

FIG. 3 is a diagram illustrating an example of a captured image acquired by a camera according to an embodiment of the present invention;

FIG. 4 is a block diagram illustrating a configuration of a substantial part of a vehicle position estimation apparatus of vehicle according to an embodiment of the present invention;

FIG. 5 is a flowchart showing an example of processing executed by a CPU of the controller in FIG. 4; and

FIG. 6 is a diagram explaining a rectangular region including a moving object.

### DETAILED DESCRIPTION OF THE INVENTION

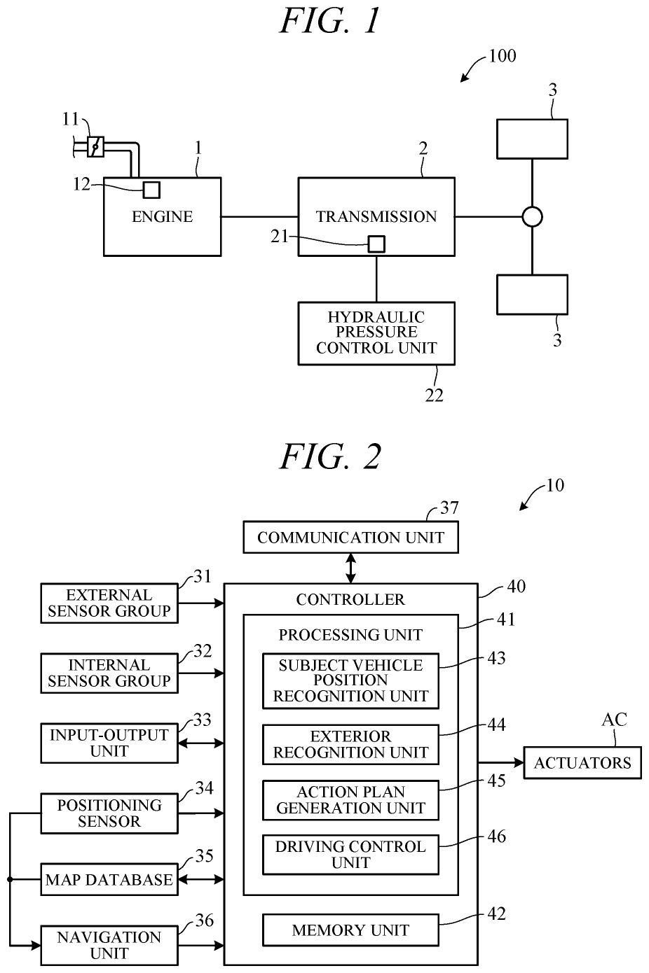

Hereinafter, an embodiment of the present invention is explained with reference to FIGS. 1 to 6. A vehicle control system according to an embodiment of the present invention is applied to a vehicle (self-driving vehicle) having a self-driving capability. FIG. 1 is a diagram showing a configuration overview of a driving system of a self-driving vehicle 100 incorporating a vehicle control system according to the present embodiment. Herein, the self-driving vehicle may be sometimes called “subject vehicle” to differentiate it from other vehicles. The vehicle 100 is not limited to driving in a self-drive mode requiring no driver driving operations but is also capable of driving in a manual drive mode by driver operations. In the present embodiment, a driving mode that does not require all operations including the accelerator pedal operation, brake operation, and steering operation is referred to as a self-driving mode.

As illustrated in FIG. 1, a vehicle 100 includes an engine 1 and a transmission 2. The engine 1 is an internal combustion engine (for example, a gasoline engine) that mixes intake air supplied via a throttle valve 11 and fuel injected from an injector 12 at an appropriate ratio, and ignites the mixture by an ignition plug or the like to burn the mixture, and thus to generate rotational power. Various engines such as a diesel engine can be used instead of the gasoline engine. An intake air amount is adjusted by the throttle valve 11, and an opening degree of the throttle valve 11 is changed by driving of a throttle actuator operated by an electric signal. The opening degree of the throttle valve 11 and an amount of fuel injected from the injector 12 (injection period, injection time) are controlled by a controller 40 (FIG. 2).

The transmission 2 is provided on a power transmission path between the engine 1 and a drive wheel 3, varies speed ratio of rotation of the engine 1, and converts and outputs a torque from the engine 1. The rotation varied by the transmission 2 is transmitted to the drive wheel 3, thereby propelling the vehicle 100. The vehicle 100 can be configured as an electric vehicle or a hybrid vehicle by providing a traveling motor as a drive power source instead of or in addition to the engine 1.

The transmission 2 is, for example, a stepped transmission enabling stepwise speed ratio according to a plurality of shift stages. A continuously variable transmission enabling stepless speed ratio shifting can also be used as the transmission 2. Although not illustrated, power from the engine 1 may be input to the transmission 2 via a torque converter. The transmission 2 includes, for example, an engagement element 21 such as a dog clutch or a friction clutch, and a hydraulic pressure control unit 22 controls a flow of oil from a hydraulic source to the engagement element 21, so that the shift stage of the transmission 2 can be changed. The hydraulic pressure control unit 22 includes a control valve driven by an electric signal, and can set an appropriate shift stage by changing a flow of pressure oil to the engagement element 21 according to the drive of the control valve.

FIG. 2 is a block diagram schematically illustrating an overall configuration of a vehicle control system 10 according to the present embodiment. As illustrated in FIG. 2, the vehicle control system 10 mainly includes a controller 40, an external sensor group 31, an internal sensor group 32, an input-output unit 33, a positioning sensor 34, a map database 35, a navigation unit 36, a communication unit 37, and actuators AC each electrically connected to the controller 40.

The external sensor group 31 is a generic term for a plurality of sensors that detect external circumstances which are peripheral information of the vehicle 100. For example, the external sensor group 31 includes a LIDAR (Light Detection and Ranging) that measures a distance from the vehicle 100 to surrounding obstacles, and a RADAR (Radio Detection and Ranging) that detects other vehicles, obstacles, and the like around the vehicle 100. Furthermore, for example, the external sensor group 31 includes a camera that is mounted on the vehicle 100, has an imaging element such as a CCD or a CMOS, and images a periphery (forward, reward and sideward) of the vehicle 100, a microphone that inputs a signal of sound from the periphery of the vehicle 100 (hereinafter, the microphone is simply referred to as a microphone), and the like. A signal detected by the external sensor group 31 and a signal input to the external sensor group 31 are transmitted to the controller 40.

The internal sensor group 32 is a collective designation encompassing a plurality of sensors that detect a traveling state of the vehicle 100 and a state inside the vehicle. For example, the internal sensor group 32 includes a vehicle speed sensor that detects a vehicle speed of the vehicle 100, an acceleration sensor that detects an acceleration in a front-rear direction of the vehicle 100 and an acceleration in a left-right direction (lateral acceleration) of the vehicle 100, an engine speed sensor that detects rotational speed of the engine 1, a yaw rate sensor that detects rotation angle speed around a vertical axis through the vehicle 100, a throttle position sensor that detects the opening degree (throttle opening) of the throttle valve 11, and the like. The internal sensor group 32 further includes a sensor that detects driver's driving operation in a manual drive mode, for example, operation of an accelerator pedal, operation of a brake pedal, operation of a steering wheel, and the like. A detection signal from the internal sensor group 32 is transmitted to the controller 40.

The input-output unit 33 is a generic term for devices in which a command is input from a driver or information is output to the driver. For example, the input-output unit 33 includes various switches to which the driver inputs various commands by operating an operation member, a microphone to which the driver inputs a command by voice, a display that provides information to the driver via a display image, a speaker that provides information to the driver by voice, and the like. The various switches include a mode select switch that instructs either a self-drive mode or a manual drive mode.

The mode select switch is configured as, for example, a switch manually operable by a driver, and outputs a mode select command to the self-drive mode in which a self-driving capability is enabled or the manual drive mode in which the self-driving capability is disabled according to a switch operation. Switching from the manual drive mode to the self-drive mode or switching from the self-drive mode to the manual drive mode can be instructed when a predetermined traveling condition is satisfied regardless of operation of the mode select switch. That is, by automatically switching the mode select switch, the mode can be automatically switched instead of manually switching.

The positioning sensor 34 is, for example, a GPS sensor, receives a positioning signal transmitted from a GPS satellite, and measures an absolute position (latitude, longitude, and the like) of the vehicle 100 based on the received signal. The positioning sensor 34 includes not only the GPS sensor but also a sensor that performs positioning using radio waves transmitted from a quasi-zenith orbit satellite. A signal (a signal indicating a measurement result) from the positioning sensor 34 is transmitted to the controller 40.

The map database 35 is a device that stores general map data used in the navigation unit 36, and is constituted of, for example, a hard disk. The map data includes road position data, road shape (curvature or the like) data, along with intersection and road branch position data. The map data stored in the map database 35 is different from high-accuracy map data stored in a memory unit 42 of the controller 40.

The navigation unit 36 is a device that searches for a target route on a road to a destination input by a driver and provides guidance along the target route. The input of the destination and the guidance along the target route are performed via the input-output unit 33. The target route is calculated based on a current position of the vehicle 100 measured by the positioning sensor 34 and the map data stored in the map database 35.

The communication unit 37 communicates with various servers not illustrated via a network including a wireless communication network such as an Internet, and acquires the map data, traffic data, and the like from the server periodically or at an arbitrary timing. The acquired map data is output to the map database 35 and the memory unit 42, and the map data is updated. The acquired traffic data includes traffic congestion data and traffic light data such as a remaining time until a traffic light changes from red light to green light.

The actuators AC are devices for operating various devices related to traveling operation of the vehicle 100. That is, the actuators AC are actuators for traveling. The actuators AC include a throttle actuator that adjusts the opening degree (throttle opening) of the throttle valve 11 of the engine 1 illustrated in FIG. 1, a shift actuator that changes the shift stage of the transmission 2 by controlling the flow of oil to the engagement element 21, a brake actuator that actuates a braking unit, a steering actuator that drives a steering unit, and the like.

The controller 40 includes an electronic control unit (ECU). Although a plurality of ECUs having different functions such as an engine control ECU and a transmission control ECU can be separately provided, in FIG. 2, the controller 40 is illustrated as a set of these ECUs for convenience. The controller 40 includes a computer including a processing unit 41 such as a CPU, a memory unit 42 such as a ROM, a RAM, and a hard disk drive, and other peripheral circuits (not illustrated).

The memory unit 42 stores highly accurate detailed map data including data on a center position of a lane, data on a boundary of a lane position, and the like. More specifically, road data, traffic regulation data, address data, facility data, telephone number data, and other data are stored as the map data. The road data includes data indicating the type of road such as a highway, a toll road, and a national highway, and data such as the number of lanes of a road, the width of each lane, a road gradient, a three-dimensional coordinate position of the road, a curvature of a curve of the lane, positions of the merging point and branch point of the lane, a road sign, and the presence or absence of a median strip. The traffic regulation data includes data indicating that traveling on a lane is restricted or a road is closed due to construction or the like. The memory unit 42 also stores data such as a shift map (shift diagram) serving as a reference of shift operation, various control programs, and a threshold used in the programs.

The processing unit 41 includes a subject vehicle position recognition unit 43, an exterior recognition unit 44, an action plan generation unit 45, and a driving control unit 46 as functional configurations related to automatic travel.

The subject vehicle position recognition unit 43 recognizes the position (subject vehicle position) of the vehicle 100 on a map based on the position data of the vehicle 100 received by the positioning sensor 34 and the map data of the map database 35. The subject vehicle position may be recognized using the map data (building shape data and the like) stored in the memory unit 42 and the peripheral information of the vehicle 100 detected by the external sensor group 31, thereby the subject vehicle position can be recognized with high accuracy. When the subject vehicle position can be measured by a sensor installed on the road or outside a road side, the subject vehicle position can be recognized with high accuracy by communicating with the sensor via the communication unit 37.

The exterior recognition unit 44 recognizes external circumstances around the vehicle 100 based on the signal from the external sensor group 31 such as a LIDAR, a radar, and a camera. For example, the position, speed, and acceleration of a surrounding vehicle (a preceding vehicle or a rear vehicle) traveling around the vehicle 100, the position of a surrounding vehicle stopped or parked around the vehicle 100, and the positions and states of other objects are recognized. Other objects include signs, traffic lights, road boundaries, road stop lines, buildings, guardrails, power poles, signboards, pedestrians, bicycles, and the like. The states of other objects include a color of a traffic light (red, green, yellow), the moving speed and direction of a pedestrian or a bicycle, and the like.

The action plan generation unit 45 generates a driving path (target path) of the vehicle 100 from a present time point to a predetermined time ahead based on, for example, the target route calculated by the navigation unit 36, the subject vehicle position recognized by the subject vehicle position recognition unit 43, and the external circumstances recognized by the exterior recognition unit 44. When there are a plurality of trajectories that are candidates for the target path on the target route, the action plan generation unit 45 selects, from among the plurality of trajectories, an optimal path that satisfies criteria such as compliance with laws and regulations and efficient and safe traveling, and sets the selected path as the target path. Then, the action plan generation unit 45 generates an action plan corresponding to the generated target path.

The action plan includes travel plan data set for each unit time Δt (for example, 0.1 seconds) from a present time point to a predetermined time T (for example, 5 seconds) ahead, that is, travel plan data set in association with a time for each unit time Δt. The travel plan data includes position data of the vehicle 100 and vehicle state data for each unit time. The position data is, for example, data of a target point indicating a two-dimensional coordinate position on the road, and the vehicle state data is vehicle speed data indicating the vehicle speed, direction data indicating the direction of the vehicle 100, or the like. The travel plan is updated every unit time.

The action plan generation unit 45 generates the target path by connecting the position data for each unit time Δt from the present time point to the predetermined time T ahead in time order. At this time, the acceleration (target acceleration) for each unit time Δt is calculated based on the vehicle speed (target vehicle speed) of each target point for each unit time At on the target path. That is, the action plan generation unit 45 calculates the target vehicle speed and the target acceleration. The target acceleration may be calculated by the driving control unit 46.

When the action plan generation unit 45 generates the target path, the action plan generation unit 45 first determines a travel mode. Specifically, the travel mode is determined, such as following traveling for following a preceding vehicle, overtaking traveling for overtaking a preceding vehicle, lane change traveling for changing a traveling lane, merging traveling for merging into a main line of a highway or a toll road, lane keeping traveling for keeping the lane so as not to deviate from the traveling lane, constant speed traveling, deceleration traveling, or acceleration traveling. Then, the target path is generated based on the travel mode.

In the self-drive mode, the driving control unit 46 controls each of the actuators AC so that the vehicle 100 travels along the target path generated by the action plan generation unit 45. That is, the throttle actuator, the shift actuator, the brake actuator, the steering actuator, and the like are controlled so that the vehicle 100 passes through a target point P for each unit time.

More specifically, the driving control unit 46 calculates a requested driving force for obtaining the target acceleration for each unit time calculated by the action plan generation unit 45 in consideration of travel resistance determined by a road gradient or the like in the self-drive mode. Then, for example, the actuators AC are feedback controlled so that an actual acceleration detected by the internal sensor group 32 becomes the target acceleration. That is, the actuators AC are controlled so that the vehicle 100 travels at the target vehicle speed and the target acceleration. In the manual drive mode, the driving control unit 46 controls each of the actuators AC in accordance with a travel command (accelerator opening or the like) from the driver acquired by the internal sensor group 32.

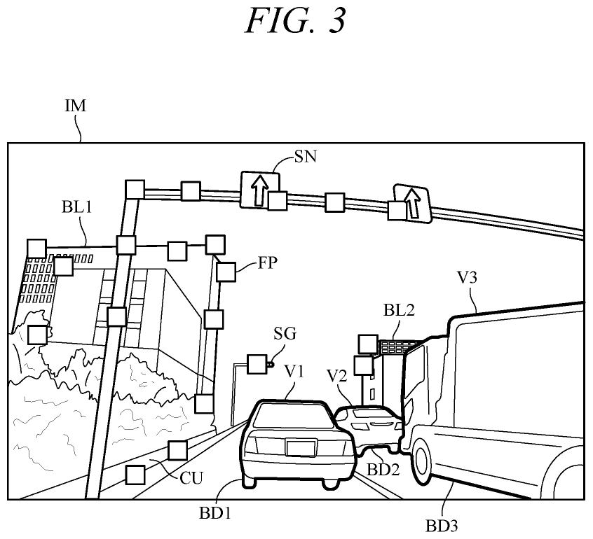

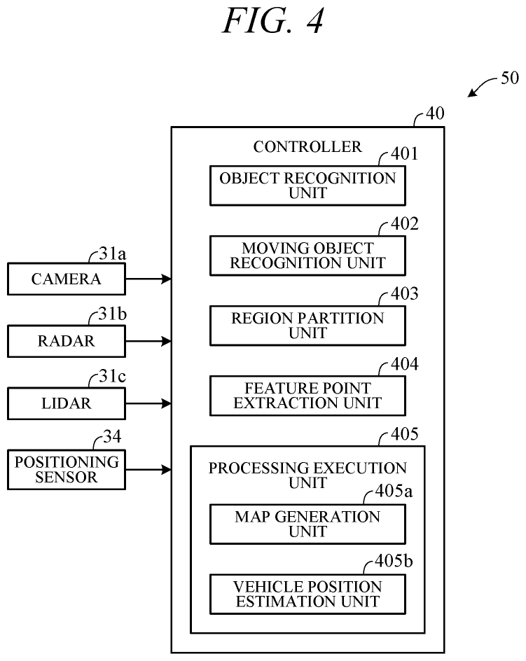

Meanwhile, when the subject vehicle position recognition unit 43 recognizes a position of the vehicle 100 using a captured image around the vehicle 100 acquired by the camera (camera 31a in FIG. 4 to be described later) of the external sensor group 31, the subject vehicle position recognition unit 43 estimates the subject vehicle position based on a relative positional relationship with respect to the object around the vehicle 100. However, the captured image acquired by a camera 31a may include a moving object such as a vehicle traveling forward. FIG. 3 is a diagram illustrating an example of the captured image acquired by the camera 31a according to the present embodiment. A captured image IM of FIG. 3 is a captured image of the front of the vehicle 100 acquired by the camera 31a of the vehicle 100 traveling on a road having two lanes on one side of left-hand traffic. Thick lines BD1, BD2, and BD3 and a square region FP in the figure will be described later. The captured image IM includes, as subjects, vehicles V1, V2, and V3 traveling in front of the vehicle 100. At this time, if the subject vehicle position is estimated based on the moving object such as the vehicles V1, V2, and V3, estimation accuracy of the subject vehicle position may be deteriorated. Thus, in the present embodiment, in order to solve such a problem, the vehicle control system 10 is configured as follows.

FIG. 4 is a block diagram illustrating a configuration of a substantial part of a vehicle position estimation apparatus 50 of the vehicle 100 according to the present embodiment. The vehicle position estimation apparatus 50 estimates the current position of the vehicle 100, and constitutes a part of the vehicle control system 10 in FIG. 2.

As illustrated in FIG. 4, the vehicle position estimation apparatus 50 includes the controller 40, the camera 31a connected to the controller 40, a radar 31b, a rider 31c, and the positioning sensor 34. A detection signal (detection data) by the external sensor group 31 including the camera 31a, the radar 31b, and the rider 31c, a detection signal (detection data) by the internal sensor group 32, and a signal (data) from the positioning sensor 34 are input to the controller 40.

The camera 31a is mounted on the vehicle 100 and images the surroundings of the vehicle 100. The camera 31a is, for example, a stereo camera including a plurality of cameras. The camera 31a outputs captured image data obtained by imaging to the controller 40. The radar 31b is mounted on the vehicle 100 and detects other vehicles, obstacles, and the like around the vehicle 100 by irradiating with electromagnetic waves and detecting reflected waves. The radar 31b outputs a detection value (detection data) to the controller 40. The rider 31c is mounted on the vehicle 100, and measures scattered light with respect to irradiation light in all directions of the vehicle 100 and detects a distance from the vehicle 100 to surrounding obstacles. The rider 31c outputs a detection value (detection data) to the controller 40.

The controller 40 includes, as functional configurations, an object recognition unit 401, a moving object recognition unit 402, a region partition unit 403, a feature point extraction unit 404, and a processing execution unit 405. Hereinafter, in order to simplify the description, a case where the controller 40 estimates the current position of the vehicle 100 using the captured image (frame image of a moving image) acquired by the camera 31a will be described as an example. However, the controller 40 can also estimate the current position of the vehicle 100 using an image (time series image) obtained by performing image processing on the detection data acquired by the radar 31b and the rider 31c in a similar manner to the case of using the captured image acquired by the camera 31a. Furthermore, the controller 40 can also estimate the current position of the vehicle 100 based on a change in position with the passage of time of three-dimensional point cloud data using the detection data (three-dimensional point cloud data) acquired by the radar 31b and the rider 31c. At that time, the controller 40 recognizes the moving object in a three-dimensional space from the three-dimensional point cloud data acquired by the radar 31b and the rider 31c, partitions a region of the recognized moving object by a cube or a contour surface (curved surface), removes a point cloud included in the partitioned region from the three-dimensional point cloud data, and then estimates the current position of the vehicle 100.

The object recognition unit 401 recognizes a subject (object) from an image (captured image) obtained by performing image processing on the detection data acquired by the camera 31a. Although the camera 31a can acquire the captured image of the surroundings of the vehicle 100 (forward, backward and sideward), hereinafter, in order to simplify the description, the captured image in front of the vehicle 100 will be used.

The object recognition unit 401 extracts an edge from the captured image acquired by the camera 31a based on luminance and color information for each pixel, and extracts a contour of the object based on information of the extracted edge (hereinafter, referred to as edge information). The edge information includes information indicating the position (coordinates), width, and the like of the edge in the captured image. As described above, the object recognition unit 401 recognizes the object included in the captured image. In the captured image IM of FIG. 3, the vehicles V1, V2, and V3, buildings BL1 and BL2, a road sign SN, a traffic light SG, and a curbstone CU are recognized by the object recognition unit 401. The object recognition unit 401 may recognize the object included in the captured image using another method.

The moving object recognition unit 402 recognizes the moving object from among the objects based on region information of each object recognized by the object recognition unit 401. The region information is information capable of specifying a region including the object, and is information indicating a position (coordinates) of the region in the captured image and a pixel value of each pixel in the region. In the captured image IM of FIG. 3, the traveling vehicles V1, V2, and V3 are recognized as the moving objects. Here, processing of the moving object recognition unit 402 will be described. Hereinafter, a current frame of the captured image is referred to as an n frame (nth frame), and the one-preceding frame of the n frame is referred to as an n−1 frame.

First, the moving object recognition unit 402 matches the region information of each object acquired from an image of the n frame with the region information of each object acquired from an image of the n−1 frame. More specifically, the moving object recognition unit 402 recognizes the object corresponding to each object in the image of the n−1 frame from the image of the n frame based on the region information (pixel value) of each object in the image of the n frame and the region information (pixel value) of each object in the image of the n−1 frame. Then, the moving object recognition unit 402 obtains a movement amount and a movement direction between the frames (between the n frame and the n−1 frame) of the recognized object. Furthermore, the moving object recognition unit 402 obtains the movement amount and the movement direction of the vehicle 100 based on the vehicle speed and rudder angle of the vehicle 100 detected from a sensor value of the internal sensor group 32. The moving object recognition unit 402 recognizes, as the moving object, the object whose movement amount and movement direction between the frames do not correspond to the movement amount and the movement direction of the vehicle 100. More specifically, when values (estimated values) of the movement amount and the movement direction of the vehicle 100 estimated based on the movement amount and the movement direction between the frames of the object are different from values (calculated values) of the movement amount and the movement direction of the vehicle 100 obtained based on the vehicle speed and the rudder angle of the vehicle 100 by a predetermined degree or more, the moving object recognition unit 402 recognizes the object as the moving object. For example, when a difference between the estimated value and the calculated value is equal to or larger than a measurement error of various sensors such as a vehicle speed sensor, it is determined that the estimated value and the calculated value are different by the predetermined degree or more. The object recognition unit 401 and the moving object recognition unit 402 constitute, for example, a part of the exterior recognition unit 44 in FIG. 2.

The region partition unit 403 partitions a region of the captured image acquired by the camera 31a into a region (hereinafter, referred to as a first region) including the moving object recognized by the moving object recognition unit 402 and a region (hereinafter, referred to as a second region) not including the moving object. More specifically, the region partition unit 403 partitions the first region and the second region such that a contour of the moving object extracted by the object recognition unit 401 becomes a boundary between the first region and the second region. The thick lines BD1, BD2, and BD3 in FIG. 3 schematically indicate boundaries that partition the first region and the second region.

The feature point extraction unit 404 extracts a feature point from the second region. The feature point is a characteristic portion in the image, and is, for example, an intersection of the edge (a corner of a building or a corner of a road sign). Each of the square regions FP in FIG. 3 schematically represents the feature point extracted from the captured image IM. The feature point extraction unit 404 may extract the feature point of the captured image acquired by the camera 31a and then remove the feature point included in the first region to extract the feature point included in the second region. Any feature point extraction method such as ORB (Oriented FAST and Rotated BRIEF) may be used to extract the feature point. The feature point extraction unit 404 may extract the feature point using the information of the edge extracted by the object recognition unit 401.

The processing execution unit 405 executes predetermined processing based on the feature point extracted by the feature point extraction unit 404. The predetermined processing includes processing (hereinafter, referred to as map creation processing) of creating an environmental map using the feature point extracted by the feature point extraction unit 404, and processing (hereinafter, referred to as vehicle position estimation processing) of estimating the position of the vehicle based on a change in position with the passage of time of the feature point extracted by the feature point extraction unit 404 on the captured image acquired by the camera 31a. The environmental map is information of a three-dimensional point cloud map on which the feature point extracted by the feature point extraction unit 404 is plotted.

The processing execution unit 405 includes a map generation unit 405a that executes the map creation processing and a vehicle position estimation unit 405b that executes the vehicle position estimation processing. The map generation unit 405a converts position coordinates (value represented in a coordinate system of the captured image) of the feature point extracted by the feature point extraction unit 404 into a value represented in a coordinate system of the environmental map and plots the value on the environmental map. The map generation unit 405a may update high-precision map information stored in the memory unit 42 based on the created environmental map.

The vehicle position estimation unit 405b calculates the movement amount and the movement direction between the frames (between the n frame and the n−1 frame) of the feature point extracted by feature point extraction unit 404. Specifically, the vehicle position estimation unit 405b detects the feature point corresponding to each feature point in the n−1 frame from the n frame, and obtains the movement amount and the movement direction between the frames of each feature point based on the position in the n−1 frame and the position in the n frame of each feature point.

The vehicle position estimation unit 405b converts a value (value represented in the coordinate system of the captured image) representing the movement amount and the movement direction of each feature point into the value represented in the coordinate system of the environmental map. Since the feature point extracted by the feature point extraction unit 404 is a feature point of an object other than the moving object, that is, a stationary object, the movement amount and the movement direction of each feature point subjected to coordinate transformation correspond to the movement amount and the movement direction of the vehicle 100 (camera 31a) on the environmental map. By integrating the movement amount and the movement direction from a reference point on the environmental map, the vehicle position estimation unit 405b estimates the position of the vehicle 100 on the environmental map. For example, the vehicle position estimation unit 405b constitutes a part of the subject vehicle position recognition unit 43 in FIG. 2. The map creation processing executed by the map generation unit 405a and the vehicle position estimation processing executed by the vehicle position estimation unit 405b are performed in parallel according to an algorithm of SLAM (Simultaneous Localization and Mapping). The vehicle position estimation unit 405b may change the value (value represented in the coordinate system of the captured image) representing the movement amount and the movement direction of each feature point to a value represented in a coordinate system of the high-precision map information stored in the memory unit 42 and estimate the position of the vehicle 100 in the high-precision map information. In the processing execution unit 405, at least one of the map creation processing executed by the map generation unit 405a and the vehicle position estimation processing executed by the vehicle position estimation unit 405b may be performed.

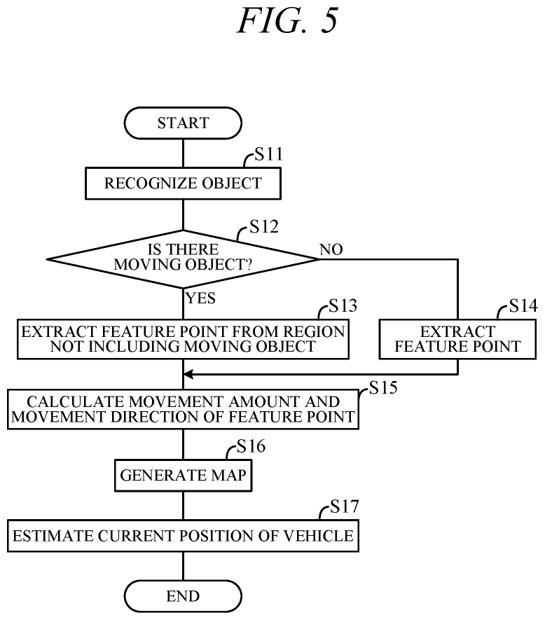

FIG. 5 is a flowchart showing an example of processing executed by the CPU of the controller 40 in FIG. 4 according to a prestored program. The processing illustrated in the flowchart is started, for example when the controller 40 is powered on, and is repeated every time the captured image is input from the camera 31a. The captured image is a moving image and is input from the camera 31a in units of frames.

First, in step S11, an object is recognized from the captured image (a frame image of a moving image) input from the camera 31a. In step S12, it is determined whether or not the moving object is present among the objects recognized in step S11.

If the determination is affirmative in step S12, the processing proceeds to step S13. When a plurality of objects are recognized in step S11, it is determined whether or not each object is the moving object in step S12, and when at least one moving object is recognized, the processing proceeds to step S13. In step S13, the region of the frame image acquired in step S11 is partitioned into the first region including the moving object and the second region not including the moving object, and the feature point is extracted from the second region. If the determination is negative in step S12, the feature point is extracted from the entire region of the frame image, acquired in step S11, in step S14. In step S15, the movement amount and the movement direction between the frames of the feature point extracted in step S14 are calculated. More specifically, a movement vector indicating the movement amount and the movement direction between the frames is calculated. When a plurality of the feature points are extracted in step S13 or S14, the movement amount and the movement direction between the frames of each feature point are calculated.

In step S16, the feature point extracted in step S13 or S14 is plotted on the environmental map. By repeatedly executing the processing illustrated in FIG. 5 while the vehicle 100 is traveling, the environmental map around the road on which the vehicle 100 has traveled is created. In step S17, the current position of the vehicle 100 is estimated. More specifically, the current position of the vehicle 100 on the environmental map is updated based on the movement amount and the movement direction of each feature point calculated in step S15.

According to the embodiment of the present invention, the following functions and effects can be obtained.

(1) The vehicle position estimation apparatus 50 includes a detection unit (for example, the camera 31a) that is mounted on the vehicle 100 and detects the external circumstance around the vehicle 100, the moving object recognition unit 402 that recognizes the moving object included in a detection region specified by the detection data acquired by the camera 31a, the region partition unit 403 that partitions the detection region specified by the detection data acquired by the camera 31a into the first region including the moving object and the second region not including the moving object, the feature point extraction unit 404 that extracts the feature point of the detection data from the second region, and the processing execution unit 405 that executes predetermined processing based on the feature point corresponding to the second region among the feature points extracted by the feature point extraction unit 404. The processing execution unit 405 executes at least one of processing of creating the point cloud map using the feature point extracted by the feature point extraction unit 404 and processing of estimating the position of the vehicle 100 based on the change in position with the passage of time of the detection data acquired by the camera 31a.

As a result, since the current position of the vehicle is estimated based on a positional relationship with the stationary object (buildings BL1, BL2 in FIG. 3, road sign SN, traffic light SG, curbstone CU, and the like) such as a road sign included in the image, the current position of the vehicle can be accurately estimated.

(2) The object recognition unit 401 extracts the contour of the moving object from the image obtained by performing image processing on the detection data acquired by the camera 31a. The region partition unit 403 partitions the first region and the second region such that the contour of the moving object extracted by the object recognition unit 401 becomes the boundary between the first region and the second region. As a result, the feature point corresponding to the moving object can be accurately removed from the feature point of the image, and the estimation accuracy of the current position of the vehicle can be further improved.

(3) When the plurality of moving objects are recognized by the moving object recognition unit 402, the region partition unit 403 partitions, as the second region, a region that is not included in any of the first regions corresponding to the plurality of moving objects among the detection regions specified by the detection data acquired by the camera 31a. As a result, for example, even when the plurality of moving objects are included in the captured image acquired by the camera 31a, the feature point corresponding to each moving object can be accurately removed from among the feature points of the captured image, and the current position of the vehicle can be accurately estimated.

In the above embodiment, although the moving object recognition unit 402 recognizes the moving object using a current image (frame image) and a past image (frame image) acquired by the camera 31a, the configuration of the recognition unit is not limited to the above-described configuration. The recognition unit may recognize the moving object from the current image acquired by the camera 31a using a learning model for recognizing the moving object in the image. The learning model is generated, for example, by performing machine learning using image data, obtained by imaging the surroundings of the vehicle traveling on the road, as teacher data, and is stored in the memory unit 42 in advance. The recognition unit may evaluate a recognition result of the moving object and update the learning model stored in the memory unit 42 based on the evaluation result. Furthermore, the recognition unit may recognize the moving object using a technology related to artificial intelligence (AI) other than machine learning.

In the above embodiment, although the object recognition unit 401 extracts the edge from the captured image acquired by the camera 31a and extracts the contour of the object included in the captured image based on the information of the extracted edge, a configuration of a contour extraction unit is not limited to the above-described configuration. For example, the contour extraction unit may extract the contour of the object from the captured image acquired by the camera 31a using a learning model constructed by machine learning. The object recognition unit 401 may extract the contour of the object using the technology related to artificial intelligence other than machine learning.

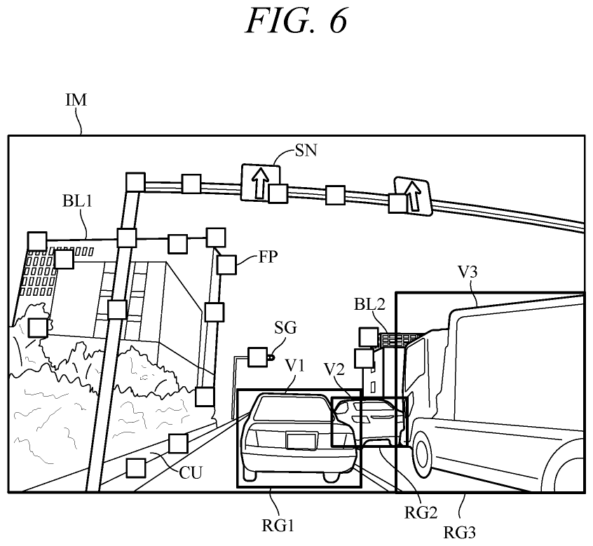

In the above embodiment, the region partition unit 403 partitions the first region and the second region such that the contour of the moving object extracted by the object recognition unit 401 becomes the boundary between the first region and the second region. However, the configuration of the region partition unit is not limited to the above-described configuration. The region partition unit may partition an inside of a rectangular region including the moving object as the first region, and partition an outside of the rectangular region including the moving object as the second region. FIG. 6 is a diagram illustrating another example of the captured image IM partitioned into the first region and the second region. Frames RG1, RG2, and RG3 drawn by thick lines in the figure represent rectangular regions corresponding to the vehicles V1, V2, and V3 which are the moving objects. In the example illustrated in FIG. 6, a region inside the frames RG1, RG2, and RG3 is partitioned as the first region by the region partition unit 403, and a region other than the first region in the region of the captured image IM is partitioned as the second region. This makes it possible to partition the first region and the second region with a processing load smaller than that in the case where the first region and the second region are partitioned with the contour of the moving object as the boundary. Therefore, even when the plurality of moving objects are included in the captured image acquired by the camera 31a, the first region and the second region can be easily partitioned. In FIG. 6, the first region is partitioned by the rectangular frames RG1, RG2, and RG3; however, the first region may be partitioned by a frame having a shape other than a rectangle.

In the above embodiment, the moving object recognition unit 402 recognizes, as the moving object, the object whose movement amount and movement direction between the frames (between the current frame and the frame acquired at a previous point of time to the current frame) do not correspond to the movement amount and movement direction of the vehicle 100 from the previous point of time to the current time, among the objects recognized by the object recognition unit 401. However, the moving object recognition unit 402 may extract a region (pixel) corresponding to the moving object on a pixel-by-pixel basis from the captured image acquired by the camera 31a using a technique of image segmentation using machine learning or the like. Then, the region partition unit 403 may partition, as the first region, the pixel (pixel group) corresponding to the moving object recognized by the moving object recognition unit 402, and partition the other pixels (pixel group) as the second region.

In the above embodiment, the moving object recognition unit 402 recognizes the moving object using the image of the current frame (n frame) and the image of the one-preceding frame (n−1 frame) of the current frame. However, if the moving object recognition unit 402 recognizes the moving object using the image of the frame acquired at the previous point of time to the current frame, the moving object may be detected using the image of the frame earlier than a predetermined number of the current frame. That is, the processing illustrated in FIG. 5 may be executed for the moving image input from the camera 31a every predetermined number m (>1) of frames. In this case, a frame interval at which the processing illustrated in FIG. 5 is executed is determined based on required accuracy of the environmental map, accuracy of position estimation, and the like. According to this configuration, it is possible to generate the environmental map and estimate the subject vehicle position with desired accuracy without increasing the processing load of the controller 40 more than necessary.

The moving object recognition unit 402 may recognize the moving object included in a current frame image based on the current frame image and a past frame image for a predetermined time continuously acquired from the current frame image. As a result, a subject that appears in the captured image acquired by the camera 31a only for a time shorter than a predetermined time, that is, a subject (such as a bird) that temporarily appears in the captured image is not recognized as the moving object. Therefore, the feature point used for estimating the current position of the vehicle can be more suitably extracted from the feature point of the captured image.

In the above embodiment, although the camera 31a detects the surroundings of the vehicle 100, the configuration of the detection unit is not limited to that described above. The detection unit may be a detection unit other than the camera 31a, such as the radar 31b or the rider 31c. In addition, in the above embodiment, although the vehicle position estimation apparatus 50 is applied to the vehicle control system of the automatic driving vehicle, the vehicle position estimation apparatus 50 is also applicable to vehicles other than the automatic driving vehicle. For example, the vehicle position estimation apparatus 50 can also be applied to a manually driven vehicle including ADAS (advanced driver-assistance systems).

The above embodiment can be combined as desired with one or more of the above modifications. The modifications can also be combined with one another.

According to the present invention, it is possible to accurately estimate the current position of the vehicle in the map information.

Above, while the present invention has been described with reference to the preferred embodiments thereof, it will be understood, by those skilled in the art, that various changes and modifications may be made thereto without departing from the scope of the appended claims.

What is claimed is:

1. A vehicle position estimation apparatus comprising
a detection unit mounted on a vehicle and detecting an external circumstance around the vehicle; and
a microprocessor and a memory coupled to the microprocessor, wherein
the microprocessor is configured to perform:
recognizing a moving object included in a detection region specified by a detection data acquired by the detection unit;
partitioning the detection region specified by the detection data acquired by the detection unit into a first region including the moving object and a second region not including the moving object;
extracting a feature point of the detection data from the second region; and
executing a predetermined processing based on the feature point corresponding to the second region among the feature points extracted in the extracting, wherein
the microprocessor is configured to perform
the executing including executing at least one of a processing of generating a point cloud map using the feature point extracted in the extracting and a processing of estimating a position of the vehicle based on a change over time in a position of the detection data acquired by the detection unit.

2. The vehicle position estimation apparatus according to claim 1, wherein
the microprocessor is configured to further perform extracting a contour of the moving object from an image obtained by performing an image processing on the detection data acquired by the detection unit, wherein
the microprocessor is configured to perform
the partitioning including partitioning the detection data into the first region and the second region so that the contour of the moving object extracted in the extracting becomes a boundary between the first region and the second region.

3. The vehicle position estimation apparatus according to claim 1, wherein
the microprocessor is configured to perform
the partitioning including partitioning an inside region of a rectangular region including the moving object as the first region and partitioning an outside region of the rectangular region as the second region.

4. The vehicle position estimation apparatus according to claim 1, wherein
the microprocessor is configured to perform
the extracting including extracting a pixel corresponding to a moving object from an image obtained by performing an image processing on the detection data acquired by the detection unit, and
the partitioning including partitioning a pixel group extracted in the extracting in the image obtained by performing the image processing on the detection data acquired by the detection unit as the first region and partitioning a region other than the first region as the second region.

5. The vehicle position estimation apparatus according to claim 1, wherein
the microprocessor is configured to perform
the partitioning including, when a plurality of moving subjects are recognized in the recognizing, partitioning a region not included in any of each first region corresponding to each of the plurality of moving subjects among the detection region specified by the detection data acquired by the detection unit as the second region.

6. The vehicle position estimation apparatus according to claim 1, wherein
the microprocessor is configured to perform
the recognizing including recognizing a moving object included in the detection region using a learning model generated by a machine learning from an image including a moving object acquired in advance.

7. The vehicle position estimation apparatus according to claim 1, wherein
the detection unit is a camera,
the camera is configured to capture a surrounding of the vehicle to acquire of a moving image in frames, and
the microprocessor is configured to perform
the recognizing including recognizing, based on an image of a current frame acquired at a current time and an image of a past frame acquired at a previous point of time to the current frame, an object of which a movement amount and a movement direction between the current frame and the past frame do not correspond to a movement amount and a movement direction of the vehicle from the previous point of time to the current time, among objects included in the image of the current frame as a moving object.

8. The vehicle position estimation apparatus according to claim 7, wherein
the microprocessor is configured to perform
the recognizing including recognizing the moving object based on the image of the current frame and the image of the past frame of a predetermined number of frames before the current frame, the predetermined number decided based on at least one of an accuracy required for the point cloud map and an accuracy required for the process of estimating the position of the vehicle.

9. The vehicle position estimation apparatus according to claim 1, wherein
the detection unit is a camera,
the camera is configured to capture a surrounding of the vehicle to acquire a moving image in frames, and
the microprocessor is configured to perform
the recognizing including recognizing, based on an image of a current frame and images of past frames for a predetermined time continued to the image of the current frame, captured by the camera, a moving object included in the image of the current frame.

10. A vehicle position estimation apparatus comprising
a detection unit mounted on a vehicle and detecting an external circumstance around the vehicle; and
a microprocessor and a memory coupled to the microprocessor, wherein
the microprocessor is configured to function as:
a recognition unit configured to recognize a moving object included in a detection region specified by a detection data acquired by the detection unit;
a region partition unit configured to partition the detection region specified by the detection data acquired by the detection unit into a first region including the moving object and a second region not including the moving object;
a feature point extraction unit configured to extracting a feature point of the detection data from the second region; and
a processing execution unit configured to executing a predetermined processing based on the feature point corresponding to the second region among the feature points extracted by the feature point extraction unit, wherein
the processing execution unit is configured to execute including executing at least one of a processing of generating a point cloud map using the feature point extracted by the feature point extraction unit and a processing of estimating a position of the vehicle based on a change over time in a position of the detection data acquired by the detection unit.

11. The vehicle position estimation apparatus according to claim 10, wherein
the microprocessor is configured to further function as
a contour extraction unit configured to perform extracting a contour of the moving object from an image obtained by performing an image processing on the detection data acquired by the detection unit, wherein
the region partition unit is configured to partition the detection data into the first region and the second region so that the contour of the moving object extracted by the contour extraction unit becomes a boundary between the first region and the second region.

12. The vehicle position estimation apparatus according to claim 10, wherein
the region partition unit is configured to partition including partitioning an inside region of a rectangular region including the moving object as the first region and partitioning an outside region of the rectangular region as the second region.

13. The vehicle position estimation apparatus according to claim 10, wherein
the recognition unit is configured to extract a pixel corresponding to a moving object from an image obtained by performing an image processing on the detection data acquired by the detection unit, and
the region partition unit is configured to partition a pixel group extracted by the recognition unit in the image obtained by performing an image processing on the detection data acquired by the detection unit as the first region and partitioning a region other than the first region as the second region.

14. The vehicle position estimation apparatus according to claim 10, wherein
the region partition unit is configured to, when a plurality of moving subjects are recognized by the recognition unit, partition a region not included in any of each first region corresponding to each of the plurality of moving subjects among the detection region specified by the detection data acquired by the detection unit as a second region.

15. The vehicle position estimation apparatus according to claim 10, wherein
the recognition unit is configured to recognize a moving object included in the detection region using a learning model generated by a machine learning from an image including a moving object acquired in advance.

16. The vehicle position estimation apparatus according to claim 10, wherein
the detection unit is a camera,
the camera is configured to capture a surrounding of the vehicle to acquire a moving image in frames, and
the recognition unit is configured to recognize, based on an image of a current frame acquired at a current time and an image of a past frame acquired at a previous point of time to the current frame, an object of which a movement amount and a movement direction between the current frame and the past frame do not correspond to a movement amount and a movement direction of the vehicle from the previous point of time to the current time, among objects included in the image of the current frame as a moving object.

17. The vehicle position estimation apparatus according to claim 16, wherein
the recognition unit is configured to recognize the moving object based on the image of the current frame and the image of the past frame of a predetermined number of frames before the current frame, the predetermined number decided based on at least one of an accuracy required for the point cloud map and an accuracy required for the process of estimating the position of the vehicle.

18. The vehicle position estimation apparatus according to claim 10, wherein
the detection unit is a camera,
the camera is configured to capture a surrounding of the vehicle to acquire a moving image in frames, and
the recognition unit is configured to recognize including recognizing, based on an image of a current frame and images of past frames for a predetermined time continued to the image of the current frame, captured by the camera, a moving object included in the image of the current frame.
